(19) United States
(12) Patent Application Publication
(10) Pub. No.: US 2015/0308308 A1
(43) Pub. Date: Oct. 29, 2015

(54) OIL CIRCULATION STRUCTURE IN INTERNAL COMBUSTION ENGINE

(71) Applicant: TOYOTA JIDOSHA KABUSHIKI KAISHA, Toyota-shi (JP)

(72) Inventor: Tsutomu WAKIYA, Toyota-shi (JP)

(21) Appl. No.: 14/671,230

(22) Filed: Mar. 27, 2015

(30) Foreign Application Priority Data
Apr. 25, 2014 (JP) 2014-091188

(51) Int. Cl. F01M 11/02; F02F 1/16; F02F 1/42

(52) U.S. Cl. CPC F01M 11/02; F02F 1/4264; F02F 1/16; F01M 2011/022

(57) ABSTRACT

An oil circulation structure in an internal combustion engine, the oil circulation structure includes a cylinder block and a cylinder head. The cylinder head includes a plurality of exhaust ports. The cylinder head has a plurality of oil holes opened on a surface making contact with the cylinder block. Oil is supplied to the cylinder block through the plurality of oil holes. The plurality of oil holes includes a first oil hole and a second oil hole. The first oil hole is placed further outside an outermost exhaust port in a longitudinal direction of the cylinder block. The second oil hole is placed further outside the first oil hole in the longitudinal direction of the cylinder block, and the second oil hole has a diameter larger than a diameter of the first oil hole.

### INCORPORATION BY REFERENCE

The disclosure of Japanese Patent Application No. 2014-091188 filed on Apr. 25, 2014 including the specification, drawings and abstract is incorporated herein by reference in its entirety.

### BACKGROUND OF THE INVENTION

1. Field of the Invention

The present invention relates to an oil circulation structure in an internal combustion engine.

2. Description of Related Art

As an oil circulation structure in an internal combustion engine, there has been known such a structure in which a plurality of oil holes for flowing oil into a cylinder block from a cylinder head provided with a plurality of exhaust ports is formed in the cylinder head. Japanese Patent Application Publication No. 2013-155625 (JP 2013-155625 A) describes that the oil holes are formed between the exhaust ports in the cylinder head, and further, the oil hole is formed outside an outermost exhaust port in a longitudinal direction of the cylinder head so that the oil hole is adjacent to the outermost exhaust port.

### SUMMARY OF THE INVENTION

In the oil circulation structure in the internal combustion engine, in a case where the oil holes are formed as described in JP 2013-155625 A, oil passing through the oil holes receives heat from exhaust gas in the exhaust ports, so that a temperature of the oil may be easily increased due to the heat.

The present invention provides an oil circulation structure in an internal combustion engine which circulation structure is able to restrain an increased in temperature of oil.

A first aspect of the present invention relates to an oil circulation structure in an internal combustion engine. The oil circulation structure includes a cylinder block and a cylinder head. The cylinder head includes a plurality of exhaust ports. The cylinder head has a plurality of oil holes opened on a surface making contact with the cylinder block. Oil is supplied to the cylinder block through the plurality of oil holes. The plurality of oil holes includes a first oil hole and a second oil hole. The first oil hole is placed outside an outermost exhaust port in a longitudinal direction of the cylinder block. The second oil hole is placed outside the first oil hole in the longitudinal direction of the cylinder block. The second oil hole has a diameter larger than a diameter of the first oil hole.

In the oil circulation structure, the cylinder block may include an oil receiving portion and a water jacket. The oil receiving portion may be configured to receive oil from the plurality of oil holes. The water jacket may be adjacent to the oil receiving portion. According to the oil circulation structure, the oil flowing into the oil receiving portion from the second oil hole is effectively cooled down by heat exchange with the cooling water flowing through the water jacket adjacent to the oil receiving portion.

In the oil circulation structure, the second oil hole may have an opening on a cylinder-block side. An inner peripheral surface of the second oil hole may include a second portion on a cylinder-block side of the second oil hole. A diameter of the second portion may be expanded toward the opening of the second oil hole.

In the oil circulation structure, the first oil hole may have an opening on a cylinder-block side. An inner peripheral surface of the first oil hole may have on a cylinder-block side of the first oil hole. A diameter of the first portion may be expanded toward the opening of the first oil hole.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a plan view diagrammatically illustrating a structure of exhaust ports in a cylinder head of an internal combustion engine, according to the present embodiment;

FIG. 2 is a schematic drawing of the cylinder head and a cylinder block in the internal combustion engine of FIG. 1, when viewed from a direction of an arrow II-II; and

FIG. 3 is a perspective view of an opening of a first oil hole and an opening of a second oil hole, according to the present embodiment, when viewed from an oil-receiving-portion side.

### DETAILED DESCRIPTION OF EMBODIMENTS

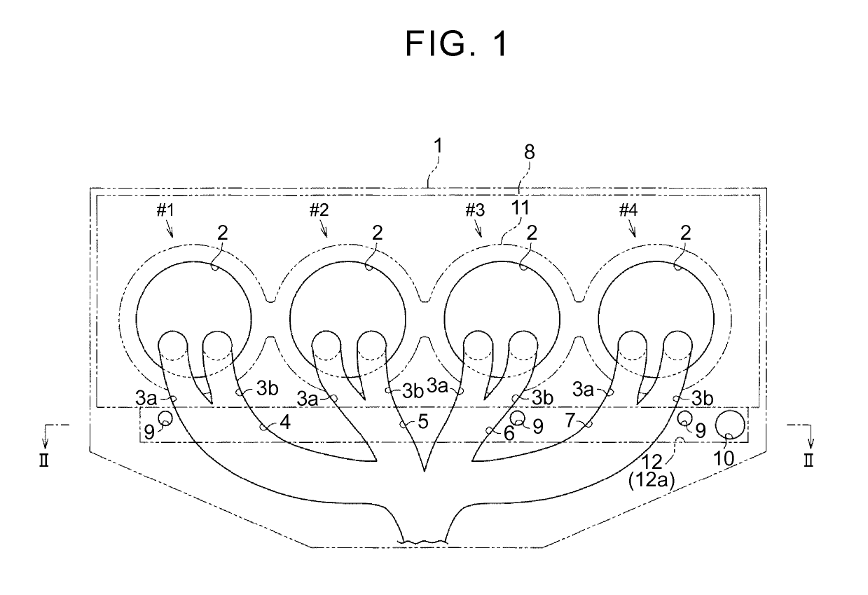

One embodiment of an oil circulation structure in an internal combustion engine is described below with reference to FIGS. 1 to 3. As illustrated in FIG. 1, a cylinder head 1 of the internal combustion engine is fixed to a top face of a cylinder block 8. The cylinder block 8 is provided with a water jacket 11 to flow cooling water for the engine. In the cylinder head 1, each of four cylinders #1 to #4 disposed in a line is provided with a plurality of exhaust ports 3a, 3b (in this example, two exhaust ports for one cylinder). The plurality of exhaust ports 3a, 3b is disposed in a direction where the cylinders #1 to #4 are aligned, that is, in parallel with a longitudinal direction of the cylinder block 8. The exhaust ports 3a, 3b are connected to a combustion chamber 2 of their corresponding cylinder.

The exhaust port 3a and the exhaust port 3b of the first cylinder #1 are joined at a downstream in an exhaust-gas flowing direction so as to form a collective exhaust port 4. The exhaust port 3a and the exhaust port 3b of the second cylinder #2 are joined at a downstream in an exhaust-gas flowing direction so as to form a collective exhaust port 5. The exhaust port 3a and the exhaust port 3b of the third cylinder #3 are joined at a downstream in an exhaust-gas flowing direction so as to form a collective exhaust port 6. The exhaust port 3a and the exhaust port 3b of the fourth cylinder #4 are joined at a downstream in an exhaust-gas flowing direction so as to form a collective exhaust port 7. The collective exhaust ports 4 to 7 are joined at a further downstream. The collective exhaust ports 4 to 7 are aligned in the same direction as the direction (a right-left direction in the figure) where the first to fourth cylinders #1 to #4 are aligned.

The cylinder head 1 has a plurality of oil holes 9, 10 to flow, from the cylinder head 1 to the cylinder block 8, oil that has lubricated a valve system and so on in the internal combustion engine, and the plurality of oil holes 9, 10 is formed in parallel with the longitudinal direction of the cylinder block 8. The oil holes 9, 10 are opened on a surface of the cylinder head 1 which makes contact with the cylinder block 8. The plurality of oil holes 9, 10 includes: first oil holes 9 adjacent to the collective exhaust ports 4, 6, 7; and a second oil hole 10 provided further outside an outermost first oil hole 9 in the longitudinal direction of the cylinder block 8, the second oil hole 10 being placed farther from the collective exhaust port 7 than the outermost first oil hole 9. The first oil hole 9 adjacent to the outermost collective exhaust port 7 in the longitudinal direction of the cylinder block 8 is placed further outside the collective exhaust port 7. Further, the second oil hole 10 is placed further outside the first oil hole 9 adjacent to the collective exhaust port 7, in the longitudinal direction of the cylinder block 8. The second oil hole 10 is formed to have a diameter larger than that of the first oil hole 9.

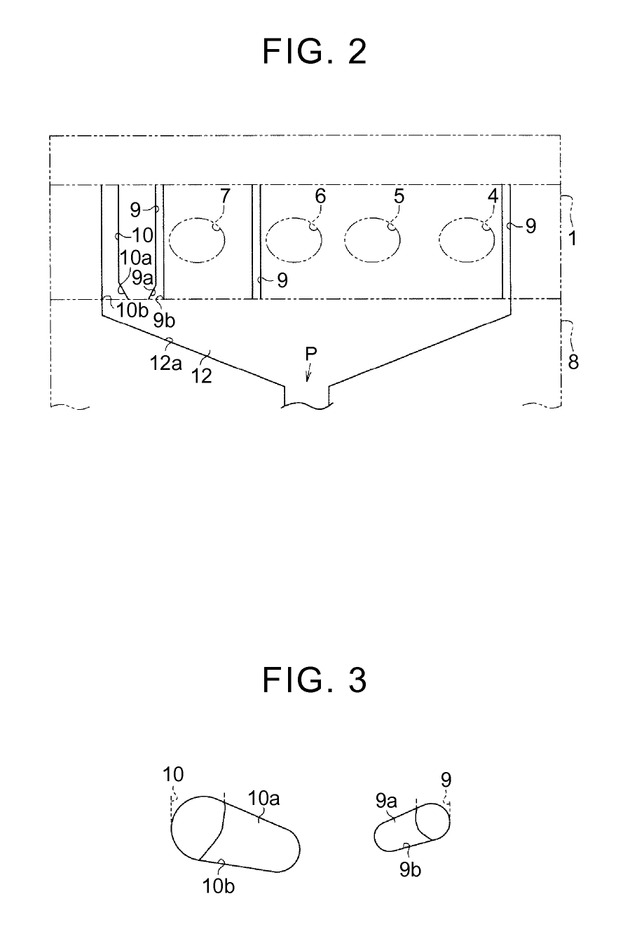

FIG. 2 is a schematic drawing of the cylinder head 1 and the cylinder block 8 in FIG. 1, when viewed from a direction of an arrow II-II. As illustrated in FIG. 2, the cylinder block 8 includes an oil receiving portion 12 for receiving oil from the plurality of oil holes 9, 10, and the oil receiving portion 12 is formed so as to be adjacent to the water jacket 11 (FIG. 1). Further, the oil receiving portion 12 is formed in a shape extended long in the longitudinal direction of the cylinder block 8, and has an inner wall 12a of a shape for collecting, into a collecting portion P, the oil flowing from the plurality of the oil holes 9, 10. The collecting portion P of the oil receiving portion 12 is placed in a central part in an extending direction of the oil receiving portion 12 (in the longitudinal direction of the cylinder head 8), and is connected to an oil pan for retaining oil that lubricates each part of the cylinder internal combustion engine.

As illustrated in FIG. 3, a portion of the inner peripheral surface of the second oil hole 10 which is closer to an opening 10b on a cylinder-block-8 side (an oil-receiving-portion-12 side) is provided with an expanded portion 10a formed by expanding the second oil hole 10 toward the opening 10b. FIG. 3 is a perspective view illustrating the second oil hole 10 illustrated in FIG. 2 and the first oil hole 9 closest to the second oil hole 10 (the first oil hole 9 adjacent to the collective exhaust port 7), when viewed from a cylinder-block-8 side. As can be seen from FIG. 3, a portion of the inner peripheral surface of the first oil hole 9 closest to the second oil hole 10 which is closer to an opening 9b on an oil-receiving-portion-12 side is provide with an expanded portion 9a formed by expanding the first oil hole 9 toward the opening 9b.

Next will be described an operation of the oil circulation structure in the internal combustion engine. Oil that has lubricated the valve system and so on in the cylinder head 1 of the internal combustion engine illustrated in FIG. 2 flows into the oil receiving portion 12 of the cylinder block 8 through the first oil holes 9 and the second oil hole 10. When the oil in the second oil hole 10 flows into the oil receiving portion 12, the oil diffuses due to the portion of the inner peripheral surface of the second oil hole 10 which is closer to the opening 10b on the cylinder-block-8 side, that is, the oil diffuses due to the expanded portion 10a. Further, when the oil in the first oil hole 9 closest to the second oil hole 10 flows into the oil receiving portion 12, the oil diffuses due to the portion of the inner peripheral surface of the first oil hole 9 which is closer to the opening 9b on the cylinder-block-8 side, that is, the oil diffuses due to the expanded portion 9a. Then, the oil flowing into the oil receiving portion 12 from the first oil holes 9 and the second oil hole 10 flows into the collecting portion P along the inner wall 12a of the oil receiving portion 12. Further, the oil thus collected in the collecting portion P of the oil receiving portion 12 is further returned to the oil pan of the internal combustion engine. The oil in the oil pan is sent to each part such as the valve system or the like of the internal combustion engine, and after the oil lubricates the each part, the oil is returned to the oil pan.

At the time when the oil is flowed into the cylinder block 8 (the oil receiving portion 12) from the cylinder head 1, the oil flowing through the second oil hole 10 is hard to receive heat from exhaust gas in the collective exhaust ports 4 to 7, as compared with the oil flowing through the first oil holes 9. This is because the second oil hole 10 is formed at a position farther from the collective exhaust ports 4 to 7 than the first oil holes 9. Further, the first oil hole 9 adjacent to the collective exhaust port 7 is placed between the second oil hole 10 and the collective exhaust port 7. The oil flowing through the first oil hole 9 interrupts heat transmission from the collective exhaust port 7 to the second oil hole 10. Hereby, the oil flowing through the second oil hole 10 is hard to receive heat from the exhaust gas in the collective exhaust port 7. Further, the second oil hole 10 is formed to have a diameter larger than that of the first oil hole 9. This can increase a flow rate of the oil flowing through the second oil hole 10, among the oil flowing from the cylinder head 1 to the cylinder block 8 (the oil receiving portion 12) through the oil holes 9, 10. By increasing the flow rate of the oil in the second oil hole 10 that is hard to receive heat from the exhaust gas in the collective exhaust ports 4 to 7 as described above, it is possible to restrain an increase in temperature of the oil flowing from the cylinder head 1 to the cylinder block 8 (the oil receiving portion 12).

According to the above embodiment described above, it is possible to obtain the following effects. It is possible to restrain an increase in temperature of the oil flowing from the cylinder head 1 to the cylinder block 8.

The water jacket 11 for flowing cooling water for the internal-combustion engine is formed adjacent to the oil receiving portion 12 in the cylinder block 8. Accordingly, the oil flowing into the oil receiving portion 12 from the second oil hole 10 is effectively cooled down by heat exchange with the cooling water flowing through the water jacket 11 adjacent to the oil receiving portion 12.

The oil receiving portion 12 is formed in a shape extended long in the longitudinal direction of the cylinder block 8. Then, the oil flowing into the oil receiving portion 12 from the second oil hole 10 flows into the collecting portion P along the inner wall 12a of the oil receiving portion 12 over a long distance. In this case, the heat exchange between the oil of the oil receiving portion 12 and the cooling water of the water jacket 11 can be performed through the oil receiving portion 12 formed in a shape extended long as mentioned earlier. This makes it possible to further effectively cool down the oil flowing into the oil receiving portion 12 from the second oil hole 10.

At the time when the oil in the second oil hole 10 flows into the oil receiving portion 12, the oil diffuses due to the portion of the inner peripheral surface of the second oil hole 10 which is closer to the opening 10b on the cylinder-block-8 side, that is, the oil diffuses due to the expanded portion 10a. Hereby, the oil flows over a large range of the inner wall 12a of the oil receiving portion 12 and then gathers at the collecting portion P. Accordingly, before the oil flows into the oil receiving portion 12 and gathers at the collecting portion P, the oil is effectively cooled down by heat exchange with the cooling water flowing through the water jacket 11.

At the time when the oil in the first oil hole 9 closest to the second oil hole 10 flows into the oil receiving portion 12, the oil diffuses due to the portion of the inner peripheral surface of the first oil hole 9 which is closer to the opening 9b on the cylinder-block-8 side, that is, the oil diffuses due to the expanded portion 9a. Hereby, the oil flows over a large range of the inner wall 12a of the oil receiving portion 12 and then gathers at the collecting portion P. Accordingly, before the oil flows into the oil receiving portion 12 and gathers at the collecting portion P, the oil is effectively cooled down by heat exchange with the cooling water flowing through the water jacket 11.

Note that the above embodiment can be modified as follows, for example. An expanded portion 9a may be formed in any of the first oil holes 9 other than the first oil hole 9 closest to the second oil hole 10.

The expanded portion 9a of the first oil hole 9 and the expanded portion 10a of the second oil hole 10 may not necessarily be provided. It is conceivable that the collecting portion P is provided on an end (a right end in FIG. 2) of the oil receiving portion 12 which end is opposite to the part just under the second oil hole 10 instead of providing the collecting portion P in the central part in the extending direction of the oil receiving portion 12 (in the longitudinal direction of the cylinder block 8) as illustrated in

FIG. 2. In this case, a distance before the oil flowing into the oil receiving portion 12 from the second oil hole 10 reaches the collecting portion P is longest, which makes it possible to effectively cool down the oil before the oil reaches the collecting portion P.

Instead of forming the oil receiving portion 12 in the cylinder block 8, a plurality of passages respectively communicating with the oil holes 9, 10 may be formed in the cylinder block 8, so that the oil in each of the holes 9, 10 is returned into the oil pan separately via its corresponding passage.

The exhaust port 3a and the exhaust port 3b of each of the cylinders #1 to #4 are joined per cylinder so as to form each of the collective exhaust ports 4 to 7, and the collective exhaust ports 4 to 7 are further joined at the downstream in the exhaust-gas flowing direction. However, instead of this, all of the exhaust ports 3a, 3b of the cylinders #1 to #4 may be joined at a predetermined part in the exhaust-gas flowing direction.

It is not necessary to join the collective exhaust ports 4 to 7 together in the cylinder head 1. The collective exhaust ports 4 to 7 may be opened outward from the cylinder head, and an exhaust manifold may be connected to openings of the collective exhaust ports 4 to 7, so that respective exhaust gases from the collective exhaust ports 4 to 7 are collected by the exhaust manifold.

Note that, in a case where the collective exhaust ports 4 to 7 are joined together in the cylinder head 1 as described in the above embodiment, the cylinder head 1 is easy to receive heat from the exhaust gas. In view of this, the application of the present invention yields a large effect.

According to the above-mentioned embodiment and examples, a flow rate of the oil flowing through the second oil hole is increased, among the oil flowing from the cylinder head to the cylinder block through the oil holes. The oil flowing through the second oil hole is hard to receive heat from exhaust gas in the exhaust port, as compared with the oil flowing through the first oil hole. This is because the second oil hole is formed at a position farther from the exhaust port than the first oil hole, and heat transmission from the exhaust port to the second oil hole is interrupted by the oil flowing through the first oil hole placed between the second oil hole and the exhaust port. By increasing the flow rate of the oil in the second oil hole that is hard to receive heat from the exhaust gas in the exhaust port as described above, it is possible to restrain an increase in temperature of the oil flowing from the cylinder head to the cylinder block.

According to the oil circulation structure of the embodiment and the examples, when the oil in the second oil hole flows into the oil receiving portion, the oil diffuses due to the second portion of the inner peripheral surface of the second oil hole which is closer to the opening on the cylinder-block side (the oil-receiving-portion side), that is, the oil diffuses due to the second portion expanded toward the opening. As a result, since the oil flows over a wide range of an inner wall of the oil receiving portion, the oil can be effectively cooled down by heat exchange with the cooling water of the water jacket.

According to the oil circulation structure of the embodiment and the examples, when the oil in the first oil hole flows into the oil receiving portion, the oil diffuses due to the first portion of the inner peripheral surface of the first oil hole which is closer to the opening on the cylinder-block side (the oil-receiving-portion side), that is, the oil diffuses due to the first portion expanded toward the opening. As a result, since the oil flows over a wide range of the inner wall of the oil receiving portion, the oil can be effectively cooled down by heat exchange with the cooling water of the water jacket. Accordingly, if the oil passing through the first oil hole receives heat from the exhaust gas in the exhaust port and its temperature is increased, the oil is effectively cooled down while the oil flows along the inner wall of the oil receiving portion, thereby restraining a temperature increase of the oil.

What is claimed is:

1. An oil circulation structure in an internal combustion engine, the oil circulation structure comprising:
a cylinder block; and
a cylinder head including a plurality of exhaust ports, the cylinder head having a plurality of oil holes opened on a surface making contact with the cylinder block, oil being supplied to the cylinder block through the plurality of oil holes, the plurality of oil holes including a first oil hole and a second oil hole, the first oil hole being placed outside an outermost exhaust port in a longitudinal direction of the cylinder block, the second oil hole being placed outside the first oil hole in the longitudinal direction of the cylinder block, and the second oil hole having a diameter larger than a diameter of the first oil hole.

2. The oil circulation structure according to claim 1, wherein
the cylinder block includes an oil receiving portion and a water jacket, the oil receiving portion is configured to receive oil from the plurality of oil holes, and the water jacket is adjacent to the oil receiving portion.

3. The oil circulation structure according to claim 2, wherein
the second oil hole having an opening on a cylinder-block side, and
an inner peripheral surface of the second oil hole includes a second portion on the cylinder-block side of the second oil hole, a diameter of the second portion becomes larger toward the opening of the second oil hole.

4. The oil circulation structure according to claim 3, wherein
the first oil hole having an opening on the cylinder-block side, and
an inner peripheral surface of the first oil hole includes a first portion on the cylinder-block side of the first oil hole, a diameter of the first portion becomes larger toward the opening of the first oil hole.
